(19) United States
(12) Patent Application Publication
(10) Pub. No.: US 2001/0037405 A1
(43) Pub. Date: Nov. 1, 2001

(54) Wireless web generation from conventional web sites by pattern identification and dynamic content extraction

(76) Inventor: Sinnathambi Mohamed Sideek, Apex, NC (US)

Correspondence Address: SINNATHAMBI MOHAMED SIDEEK, 513 PINEY WOODS LN, APEX, NC, 27502, US

(21) Appl. No.: 09/827,529

(22) Filed: Apr. 6, 2001

Related U.S. Application Data
(60) Provisional application No. 60/195,883, filed on Apr. 7, 2000.

(51) Int. Cl. G06F 15/16

(52) U.S. Cl. 709/246

(57) ABSTRACT

A method and system for generating wireless web site based on the user's interaction with corresponding conventional web site. The user interacts with the conventional web site in a browser simulator. The data flowing in and out of the simulator is captured. The user selects the desired output for wireless device by highlighting it in the simulator. The generated web services provide a user interface for wireless devices to capture the data that is passed to conventional web service, receive the data from wireless devices and dynamically generate request to conventional site with the data, extract the desired portion of the output from the result obtained from conventional web site in a canonical fashion using the identified pattern extraction rules, format and passes the extracted data for wireless devices.

### CROSS REFERENCE TO RELATED APPLICATIONS

This application is entitled to the benefit of Provisional Patent Application Ser. No. 60/195,883, filed Apr. 7, 2000.

### BACKGROUND

1. Field of Invention

This invention describes a system and method for generating proxy wireless web by dynamically interacting with corresponding conventional web site and extracting and formatting desired data using canonical rules.

2. Background

Conventional web sites have been created for browsing from computers that have large display sizes. On the other hand, the display screen in wireless enabled devices like cell phones and Personal Digital Assistants (PDA) are limited in size—typically 3 to 12 lines of display. Hypertext Markup Language (HTML) is used to format web pages for display in conventional web browsers such as Internet Explorer by Microsoft Corporation of Redmond Wash., Netscape Navigator of Netscape Communications of Mountain View Calif. and others. Hyper Text Transfer Protocol (HTTP) is used to transfer these pages to web browser. The Internet ready wireless phones use Wireless Markup Language (WML) or Handheld Device Markup Language (HDML) to format content for display in the built in micro browser. Some cellular phones use compact HTML (cHTML) to display content. The PDA's with Palm Operating System use Web Clipping—a restricted set of HTML to display content.

Conventional web based services normally have a set of screens and hyperlinks between them for user interaction. In WML or HDML based services, a set of cards are defined and hyperlinks are associated with keys. The user navigates by pressing the appropriate keys.

Because of the restricted display size and relatively lower bandwidth and processing power available in the wireless devices, the users of these devices are primarily interested in essential and valuable information. While HTML pages in conventional webs have this information, the information is embedded with lots of other data, which is considered superfluous in wireless devices. While it is possible to define a mapping from HTML to any of the above markup languages supported by wireless devices, such a blind mapping is practically useless in the absence of powerful filtering techniques to extract only the necessary information.

In order to extend the reach of existing web based services to wireless devices, the site has to be redesigned to produce content in the markup languages supported by these devices. This approach increases implementation cost and maintenance overhead dramatically.

### SUMMARY

This invention describes a system and method for generating a proxy web site for wireless devices based on existing sites created for conventional computer browsers. The generated proxy web service dynamically interacts with the conventional web site for content and extracts the desired portion of data for wireless devices and coverts them to appropriate markup language and forwards the content to wireless devices. The system uses a browser simulator to let the user interact with existing site and mark the desired data for conversion. Based on the interaction and user's responses, it deduces rules for extracting the desired content from existing site in a canonical fashion.

### Objects and Advantages

This invention provides a tool for building proxy web sites for wireless devices, which dynamically interact with the existing web based services for content. The tool deduces rules to extract the desired data in canonical fashion based on user's interaction with existing web service.

This invention uses a user friendly browser simulator to capture the user's interaction in the conventional web sites. Also it lets the user specify the desired portion of displayed output for wireless devices. Based on the interaction and user's responses it deduces rules for extracting the desired data in a canonical way. The generated proxy web service dynamically obtains html content, extracts the desired data using the deduced rule and generates content for wireless devices in the languages supported by that device.

This approach to extend the reach of existing web based services to wireless devices, dramatically reduces implementation cost. It also ensures data is consistent independent of whether it is accessed by conventional computer browser or micro browser from wireless devices. The single source of data results in reduced maintenance overhead.

### DESCRIPTION OF DRAWINGS

FIG. 1 is the block diagram of the browser simulator used in this invention.

FIG. 2 is the flowchart for input capture process described in the next section.

FIG. 3 depicts the typical user interaction with the browser simulator to capture the input files needed for wireless web generation.

FIG. 4 is the high level flowchart for operations in wireless web generation phase.

FIG. 5 shows the flowchart for input conversion.

FIG. 6 shows the flowchart for query generation.

FIG. 7 shows the high level flowchart for pattern identification and rule detection.

FIG. 8 shows the flowchart for pattern rule 1.

FIG. 9 shows the flowchart for pattern rule 2.

FIG. 10 shows the flowchart for formatting the extracted html content into WML content.

FIG. 11 shows the format of the url.txt file generated in input capture phase.

FIG. 12 shows mapping table for HTML form elements to WML Card.

### DESCRIPTION OF PREFERRED EMBODIMENT

This invention operates in two phases.

1. Input Capture Phase

2. Wireless Web Generation Phase.

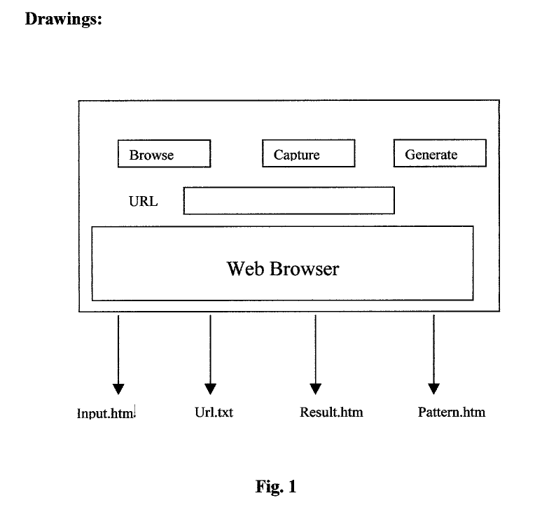

### Input Capture Phase—FIGS. 1-2, 11

The input capture phase uses a browser simulator to generate the necessary inputs needed for the subsequent wireless web generation phase. The browser simulator is shown FIG. 1. It has an instance of HTML based web browser and command buttons for the following operations.

a. Browse

b. Capture

c. Generate.

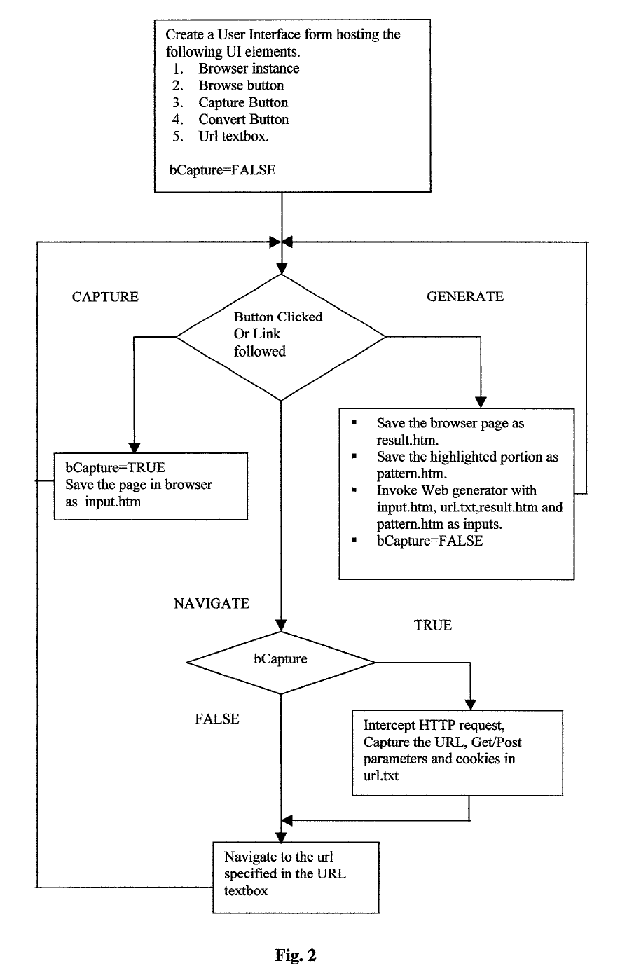

The input capture process outlined in the flowchart depicted in FIG. 2 produces the following output files.

1. input.htm—an HTML file that contains the input elements (link or form ) that are desired in wireless web.

2. url.txt—a file that lists the host, path, method (GET or POST), data and header passed in the HTTP request.

3. result.htm—a file that contains the result of GET/POST operation.

4. pattern.htm—a file that contains only the desired portion in result.htm that needs to be used in wireless web.

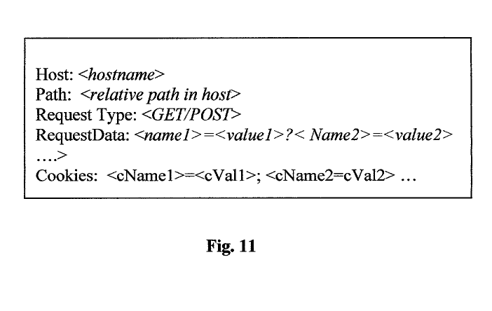

As shown in flowchart in FIG. 2, the input capture process waits for button click events after initialization. Initially, capture mode is not active and generate button is disabled. When the browse button is clicked, the browser navigates to the URL specified in URL textbox. If the capture button is clicked, the page that is currently displayed in the browser is saved as input.htm and capture mode is enabled. When the capture mode is enabled, any HTTP request that is going out is captured and the URL information and HTTP request data are saved in url.txt. The format of url.txt file is shown in FIG. 11. The browser displays the result of HTTP request. The user is allowed to highlight the desired portion of the result in this page. When generate button is clicked, the page that is displayed currently in the browser is saved as result.htm and the highlighted portion is saved as pattern.htm. Now the files generated are passed as inputs to wireless web generation process.

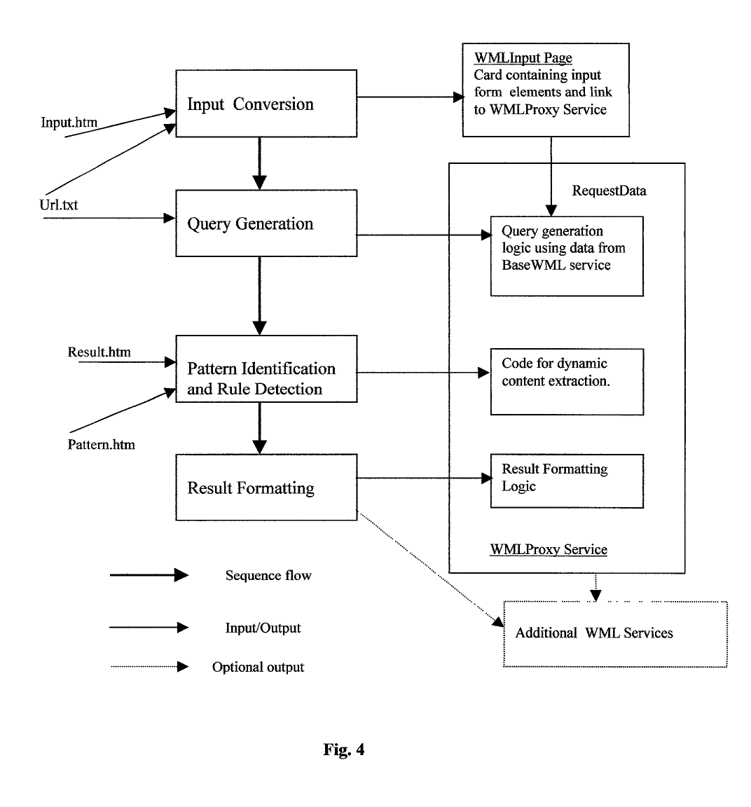

### Wireless Web Generation Phase—FIG. 4

The wireless web generation mechanism acts on the files produced in the input capture phase and uses powerful pattern matching and extraction techniques to generate the logic that is needed to dynamically produce content for wireless webs from conventional web pages. In addition to generating dynamic content, it also maps the static (unchanging) portion of the HTML form elements to WML. It also provides means for the user to select the desired format of the output wherever the options are possible. Also with the help of browser simulator, it provides means to iterate several times with different input parameters to verify the correctness of generated logic.

The different high level processes in wireless web generation are outlined in the flowchart shown in FIG. 4. The following processes operate sequentially on the files from input capture phase to produce wireless web services.

1. Input Conversion.

2. Query Generation.

3. Pattern Identification and Rule Detection.

4. Result Formatting.

The following output is generated as a result of the operations listed above.

1. WML input page: A WML service, which displays the card, corresponding to the input elements and cookies in HTML form or the HTML link. Also the generated card will have link to WML Proxy Service when ACCEPT key in wireless device is pressed.

2. WML Proxy Service: A dynamic web based service that carries out the following tasks.

a. Extract the request parameters from the WML request and generate an HTML request with these parameters to the conventional HTML service.

b. Extract the desired result from the resulting HTML page and formats it in to WML cards and passes it back as a response to the WML request.

The WML input page is generated in the input conversion process. Rest of the processes generates WML Proxy service. The wireless web generation processes are explained in detail in the following sections.

### Input Conversion FIGS. 4-5, 12

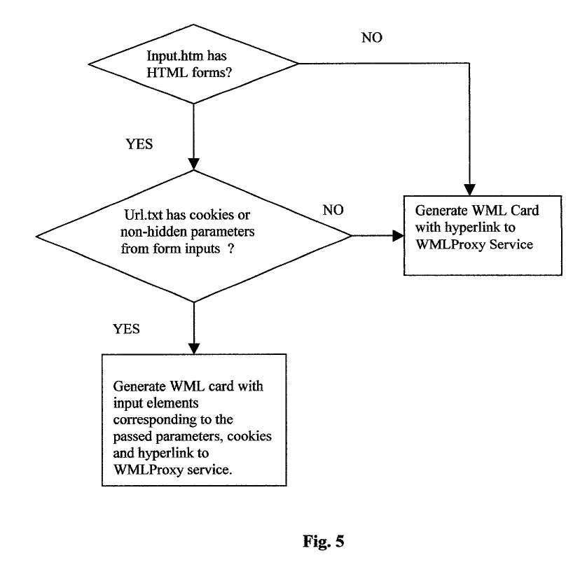

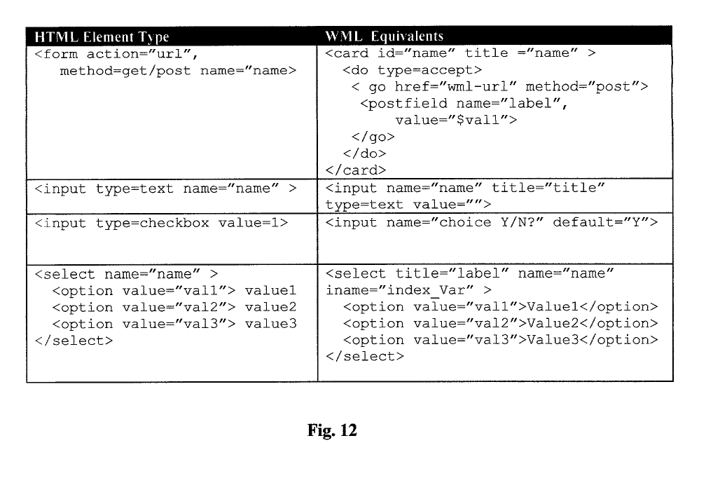

As shown in FIG. 4, input.html and url.txt files from the input capture phase are used in input conversion stage and WML input page is generated as a result. This process is outlined in flowchart shown in FIG. 5. It begins by testing input.htm for HTML form elements. Then comparing the action attribute in the form and relative path in the URL identifies the form corresponding to the user interaction. Also the parameters that are passed as inputs are identified by preparing the list of non-hidden INPUT elements and cookies appearing in the request data and header. For the list of elements identified above, corresponding WML equivalents are produced. The mapping table shown in FIG. 12 lists the WML equivalents for HTML form elements. The submit buttons which invokes HTML form action is represented by ACCEPT key with a link to WMLProxy Service. If there are no forms or no non hidden input elements in the form, just a hyperlink pointing to WML Proxy service is appended to the card.

### Query Generation—FIGS. 4,6

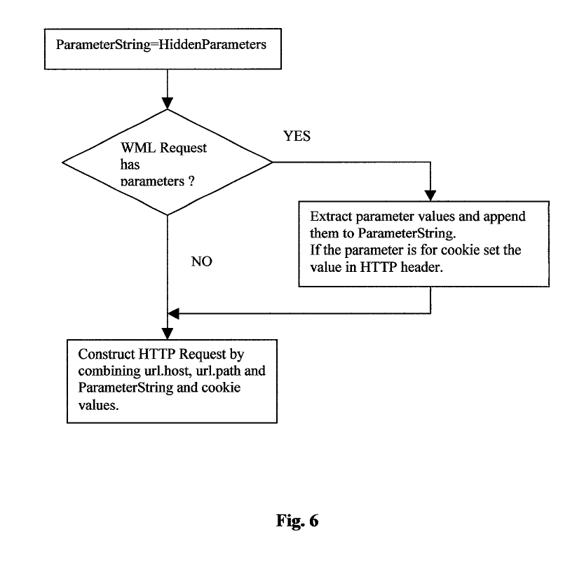

In this process, code for generating the HTML request is produced. The process of generating the logic, necessary for formulating the query to the HTML web site is outlined in the flowchart shown in FIG. 6. Initially, the list of parameters that are passed from the input form is identified and ‘Parameter’ variable is initialized with all hidden input element names and their corresponding values in the form name=“value”. The successive parameters are delimited with ‘?’ character. Non hidden parameters and cookies are passed to the WML Proxy service as request parameters. The name and values for these parameters (if any) are appended to the parameter string. Using the URL information in url.txt file, an HTTP request is issued with the parameter string as GET or POST data and cookie values in the header. In WML Proxy service, the generated request returns the HTML result page.

### Pattern Identification and Rule Detection FIGS. 4,7-9

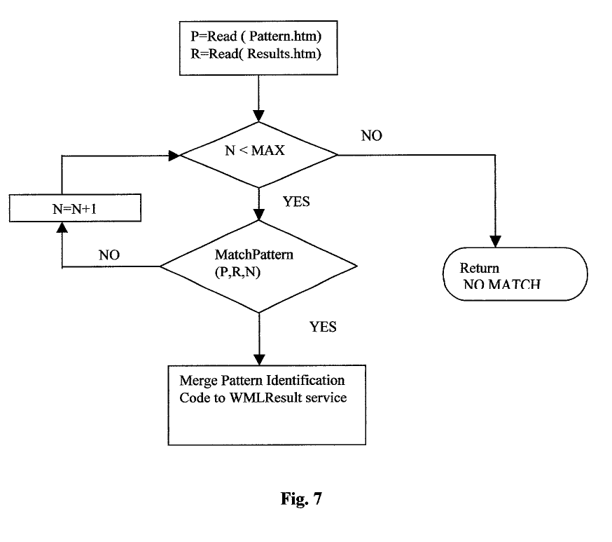

The Pattern identification process uses the result.htm and pattern.htm files generated in input capture phase. It also tests to determine whether the pattern follows a predefined rule. Once the rule is identified, the corresponding code necessary to extract the desired portion of the result is generated. The process is outlined in flowchart shown in FIG. 7.

The power of this invention lies in deducing the rule for extracting the desired data from HTML Result page in a canonical fashion, for similar inputs. For example, let us assume we have an HTML based service that gives driving directions. In this example, the result.htm is the page that has the desired directions, and pattern.htm is the desired portion of HTML within result.htm. Specifically let us say result.htm and pattern.htm has directions from point A to point B. The code generated by this stage using these specific files should be able to extract the directions in a generic fashion i.e. If the result.htm and pattern.htm has directions between point C and point D, then applying the generated logic should yield directions between point and C and D, which is not literally identical to the output generated in the previous case.

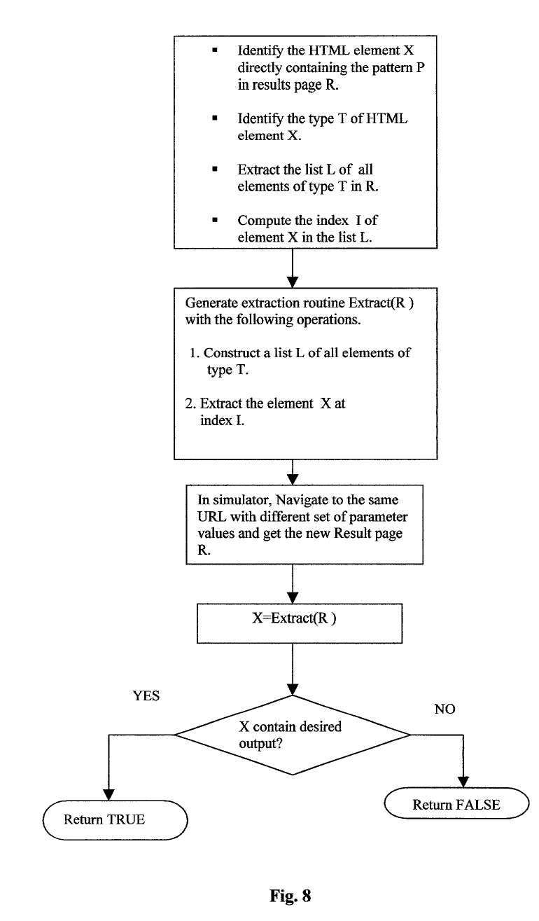

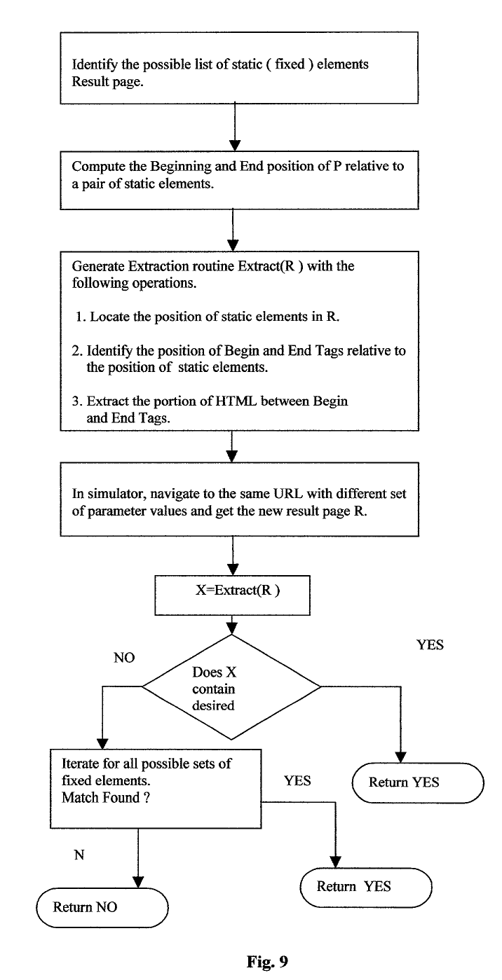

The pattern rules 1 and 2 are outlined in flowcharts in FIG. 8 and FIG. 9. More rules can be added as new patterns are identified.

### Pattern Rule 1—FIGS. 7,8

The rule relies on the positioning of desired result pattern from the beginning of HTML page. The flow of logic in matching this rule is outlined in FIG. 8. The following definitions help in understanding the flowcharts.

A HTML page consists sequences of characters and markup symbols called Tags. The markup symbols are enclosed between ‘<’ and ‘>’ characters. The general tag style is as follows:

<name attr1=“value1” attr2=“value2”>.

An element denotes the portion of HTML page between Begin and End Tags. End Tag is denoted by ‘<name>’. The name denotes the type of the HTML element such as table, tr, td etc.

The philosophy behind this rule is that the desired output appears in the result page as the HTML element whose relative starting position is unchanged when similar type of elements are grouped in the result page. The process begins by identifying the HTML element in result page, which directly encloses the pattern.htm. Then the type T of that element is determined. A list of elements of type T ordered by the relative position in the page is computed for result.htm. Then the index I of the desired HTML element in the list is computed. The code is appended to the WML Proxy Service, which does the following:

1. Compute the ordered list L of elements of type T in the result page R returned by the Query generation code.

2. Extract the element at index I in list L.

The generated logic is verified by running through the simulator with different set of input parameters as depicted in the flowchart.

### Pattern Rule 2—FIGS. 7,9

The philosophy behind this rule is that the desired output always appears in the result page at the same relative position between fixed HTML elements. The fixed HTML element always appears in the same position in the result page for the particular service. This rule begins by identifying a possible list of fixed html elements. It can be done by comparing two distinct result.htm pages obtained with different input parameters and identifying the common elements, which preserve their relative positions. As depicted in the flowchart in FIG. 9, this rule then computes the relative position of pattern element P in result page with respect to the fixed elements.

For example, in the HTML page containing the driving directions, the directions may always be listed below the heading Directions and at the end, it is followed by copyright notice. In this specific example, the rule determines the position of the beginning HTML Tag of the pattern relative to the heading Directions and the position of the last HTML Tag of pattern relative to the copyright notice computed backwards in result.htm.

The code that performs this extraction is appended to the WML Proxy service. The logic is verified by number of iterations using different input values from the simulator. If the desired result is not obtained in any of the iterations, then different set of fixed elements are tried until the match occurs or the fixed elements in the list are exhausted.

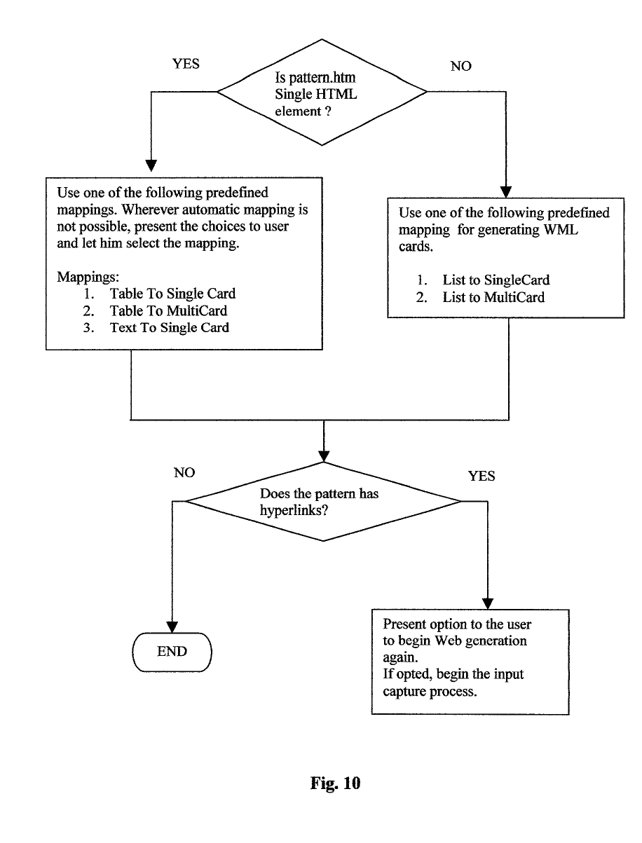

### Result Formatting—FIG. 10

In this stage, the desired portion of the html page extracted in the previous stage is converted to WML pages by using predefined mappings. The choice of the mapping is determined by the layout of pattern.htm and user selection. The operation of this process is outlined in FIG. 10.

Depending upon the user input and the structure of the desired result, one of the following mappings is typically used to generate WML output.

1. Table to single card: In this mapping, the desired result is in a HTML table. The first row in the table is expected to have column headings. The rest of the rows have data. It can be converted to WML card containing WML table element.

2. Table To MultiCard: The column headings are extracted from the first row in the table. Then for each row of data in the table, a WML card is generated with a line in the card for each column within the row. The column heading appears within brackets in each line.

3. Text To Single Card: The textual portion of the desired result is mapped to a WML Card.

4. List To Single Card: The desired portion of the result contains a list of disjoint HTML elements. The text from each element is extracted and appended to a single WML card.

5. List To MultiCard: The text from each element in the list is mapped to separate WML cards and all these cards are linked by prev and next links in WML.

The code for generating the output based on the selected mapping and for sending the generated output back to the wireless device is added to the WMLProxy Service.

The desired output portion might contain hyperlinks that may also be required in the wireless web. These hyperlinks are identified, and separate services are generated for the results by following these links using the simulator.

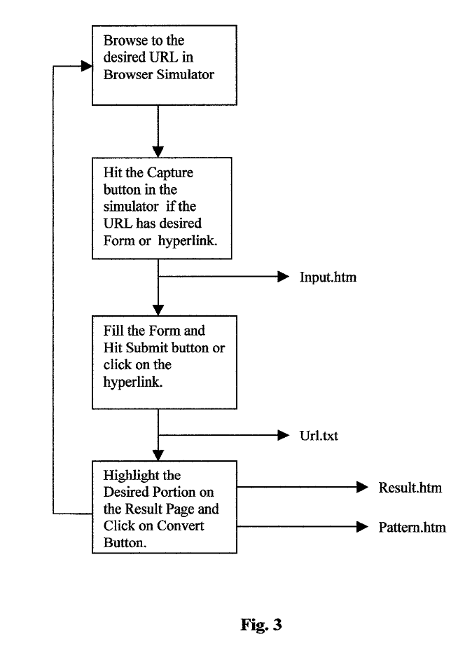

### Operation of the Invention—Fig 3

The typical user interaction in using this invention to generate the wireless web is depicted by flowchart shown in FIG. 3. The typical sequence is as follows.

1. The user begins his exploration by typing the URL in the url textbox and by clicking the browse button. The browser window navigates to the URL and displays the page returned.

2. Select the capture button, if the page is the desired one that houses the input form and hyperlink that brings information to be transformed for the wireless web. At this time the page that is displayed in the browser is saved as input.htm and capture mode is enabled.

3. The user follows the link, fills the form and clicks submit button. If the capture mode is enabled, the data that is going out in the HTTP request is saved in url.txt. The browser displays the page, which comes as a result of the request.

4. The user highlights the portion of the html page that has the desired result and clicks the generate button. The page that is displayed in the window is saved as result.htm and the highlighted portion of the page is saved in pattern.htm. The wireless web generation process begins with input.htm, url.txt, result.htm and pattern.htm files as inputs.

5. In the wireless web generation phase, most of the tasks are completed automatically and the user action is prompted to resolve ambiguity and to confirm the choices made.

a. The input conversion stage automatically generates a WML Input page for input elements in the forms. In case of hyperlinks, just a WML page with hyperlink is generated.

b. The query generation process adds code to the WML Proxy service to generate the HTML query with input from WML input page to get the result page.

c. Pattern identification and rule detection process deduces the generic filtering mechanism by matching the pattern in the result page using predefined rules. While matching the pattern with the given rule, the user might be asked to browse through the simulator several times and asked to confirm whether the generated output is correct. Also if no rule matches the pattern, the user might be asked to select a slightly different pattern which still has desired output. At the end of this phase filtering and extraction code is appended to WML Proxy service.

d. In the result formatting process, the extracted result is formatted into WML pages. While it makes some choices based on the structure of output automatically, the user is prompted to make a choice whenever options are available.

### Description and Operation of Alternative embodiments

The basic structure and principle of the invention can be easily extended to other devices supporting different languages like HDML ( Handheld Device Markup Language) used in some old generation phones, cHTML (compact HTML) used in imode phones, Web Clipping used in Palm OS based devices, VoiceXML used in voice browsers accessed by phones etc. The Input Conversion and Result formatting stages of the main embodiment will be modified to generate out put in the desired language

It is also possible to make the invention produce wireless web content based on interaction with other backend systems like database instead of existing web sites by suitably modifying the simulator to interact with the desired system. The query generation stage is modified to direct queries to the new system and appropriate pattern rules are introduced based on the output from this system.

The Pattern Identification and Rule Detection stage of the main embodiment states few rules which apply to common web based systems. Without loss of generality, other rules, which deal with special situations, can be identified and the system can be extended by substituting the new rule in this stage.

The main embodiment describes the use of the invention for a simple web based request. Most common web interactions involve several such requests to get meaningful result. This invention can be applied to this situation by repeatedly by applying methods to each of the requests in succession. Alternatively by making suitable modifications in the Input Conversion stage and Query Generation stage we can consolidate multiple requests into one.

The Result Formatting stage of the main embodiment states common rules for formatting the output to the desired language. Additional rules can be identified and added.

### Conclusion, Ramification and Scope of Invention

While the above description contains many specificities, these should not be construed as limitations on the scope of the invention, but rather as an exemplification of one preferred embodiment thereof. Many other variations are possible. For example this invention generates Wireless Web from conventional webs by making the user go through simple interaction. It can be easily extended to complex interactions by viewing them as a series of simple interactions put together.

Moreover, the generated WML pages could be customized further by defining more mappings based on specific devices and their display capabilities. More complex interaction with the pages can also be defined by mappings that contain script code for dynamic interaction.

The main embodiment describes the invention assuming the web site is HTML based. It can be easily extended to sites based on other markup languages such as XHTML,XML etc.

Accordingly, the scope of the invention should be determined not by embodiment illustrated but by appended claims and their equivalents.

I Claim:

1. A method of generating a proxy web site for wireless devices with micro browser supporting a second markup language, based on a conventional web site created for computer browsers supporting first markup language whereby said proxy web service dynamically interact with the conventional web site for content, the method comprising the following steps:
(a) interacting with said conventional web site by making a web request in a browser simulator there by capturing the input page of said conventional web site, the destination Uniform Resource Locator (URL) of said web request, the request data being passed to the destination in said web request and the result page of said web request, and marking desired content for conversion within the result page of said web request;
(b) generating a second input page in said second markup language by identifying a set of user interface elements of the input page involved in said web request, converting said set of user interface elements to equivalent ones in the second markup language and changing the destination URL of the generated input page to a proxy web service;
(c) generating request object code in the proxy web service to make web request to the destination URL of the web request captured in the simulator passing the input data coming from the web request of the second input page;
(d) selecting a matching pattern rule within plurality of pattern rules to canonically extract the desired content within the result page of the web request in the simulator and appending the object code for extraction from the selected pattern rule to the proxy web service to extract the desired data from the result of the web request made in the previous step;
(e) appending result formatting object code in the proxy web service to format the desired data extracted in second markup language using one of the predefined mappings within plurality of mappings.

2. The method of claim 1 wherein the step of interacting with the conventional browser in the browser simulator comprises the following steps:
(a) providing a graphical user interface form comprising at least three buttons labeled browse, capture and generate, a text box to get URL name and a browser for navigating to the URL;
(b) initializing the capture mode to inactive state and waiting for button click events from the browse, capture and generate buttons and invoking the corresponding handler when the button is pressed;
(c) providing a handler for browse button which will allow the browser to navigate to the URL specified in the text box;
(d) providing a handler for capture button which activate capture mode and saves the page displayed in the browser as input page;
(e) providing handler navigate event which is fired when hyperlinks are followed to save request data flowing from the browser in the web request, the destination URL and result page if capture mode is active;
(f) letting the user highlight the desired content within the result page and saving the highlighted portion in a file.

3. The method of claim 1 wherein the step of generating a second input page comprises the following steps:
(a) identifying the names of parameters passed in the captured web request data in the browser simulator;
(b) identifying the set of user interface elements within the forms in the page having the same names as the parameters and same destination URL as the captured URL in the web request;
(c) generating the second input page by converting the input elements to equivalent elements in second markup language and directing the request to a proxy web service.

4. A method of claim 1, where in the step of generating object code in the proxy web service to make web request comprises the following steps:
(a) identifying the hidden and non hidden parameters of the web request in the browser simulator using the input page and the request data captured;
(b) generating the object code for making the web request to the destination URL captured in the browser simulator by substituting the non hidden parameter values coming from the incoming web request into the request data.

5. The method of claim 1 wherein the step of selecting a matching pattern comprises the following steps:
(a) reading the desired content P and the result page R of captured web request in the simulator;
(b) storing the plurality of pattern matching rules which can uniquely identify P within R;
(c) applying pattern rules in sequence to P and R, to find a pattern rule which canonically extract P from R, canonical meaning if the rule is applied to new page R1, the extracted portion P1 is will be having desired content;
(d) adding the object code for extract-pattern procedure of the matched pattern rule to the generated proxy thereby extracting the desired pattern from the result page returned by generated web request.

6. The method of claim 5 wherein the pattern rule and applying the rule to canonically extract the pattern P within the result R comprises the following steps:
(a) finding the pattern P within result page R in the following steps:
1. identifying the hyper text markup language (HTML) element X which immediately encloses the pattern P in the result page R;
2. identifying the type T of the HTML element X;
3. extracting the list L of elements of type T in R;
4. computing the index I of element X in list L;
(b) generating extract-pattern function comprising the following steps:
1. constructing list L of all elements of type T;
2. extracting the element X at index I and returning X to the caller;
(c) allowing the user to navigate to the destination URL captured in the browser simulator with a new set of values for input parameters in the web request;
(d) applying the generated extract-pattern function to the new result page to extract desired data;
(e) allowing the user to verify the extracted result with desired result and returning verification response to the caller.

7. The method of claim 5 wherein the pattern rule and applying the rule to canonically extract the pattern P within the result page R comprises the following steps:
(a) identifying the list of fixed elements in R, the fixed elements being the elements which always appear in the result page independent of the request data passed to the request;
(b) computing the position of beginning and end tags of pattern P relative to a pair of static elements;
(c) generating an extract-pattern function comprising the following steps:
1. locating the position of static elements in R;
2. identifying the position of beginning and end tags relative to the position of static elements;
3. extracting the portion of HTML between begin and end tags;
(d) allowing the user to navigate to the destination URL captured in browser simulator with new set of values for input parameters in the web request;
(e) applying the generated extract-pattern function to the new result page to extract desired data;
(f) allowing the user to verify the extracted result with the desired content and returning the result of verification to the caller if match is found; and
(g) reiteratively repeating steps b to f with a different set of fixed elements until a match is found or all elements are exhausted and returning the result of verification to the caller.

8. The method of claim 1 wherein the second markup language is wireless markup language (WML).

9. The method of claim 1 wherein the second markup language is hand held device markup language (HDML).

10. The method of claim 1 wherein the second markup language is voice XML.

11. The method of claim 1 wherein the second markup language is web clipping (a subset of HTML used in palm devices).

12. The method of claim 1 wherein the second markup language is compact HTML (cHTML).

13. The method of claim 1, wherein the generated proxy is a Java servlet.

14. The method of claim 1, wherein the generated proxy is an Active Server Page.

15. A software tool for generating a proxy web site for wireless devices with micro browser supporting a second markup language, based on a conventional web site created for computer browsers supporting first markup language whereby said proxy web service dynamically interact with the conventional web site for content, the tool comprising the following elements:
(a) a browser simulator which will allow a user to interact with said conventional web site by making a web request and marking the desired data to be passed to said wireless devices from the result of said request, the interaction capturing the destination Uniform Resource Locator (URL), the request data being passed and the result page of the web request,
(b) input conversion means with a translator from first markup language to said second markup language, which can generate second input page in said second markup language with a link to a proxy web service by identifying the user interface elements used in said web request in said simulator to the said destination URL,
(c) request generation means to generate object code in said proxy web service to make a web request passing the data coming from said input page in second markup language,
(d) pattern rule matching means using the browser simulator to select a matching pattern rules within plurality of pattern rules to uniquely identify the desired content within the result page of the web request and add the corresponding pattern extraction code to the proxy web service to extract desired content from the result page of the web request made in the previous step.
(e) result formatting means with said translator from first markup language to second markup language to generate object code for formatting desired data extracted in the previous step to desired format.
